(19) United States
(12) Patent Application Publication
(10) Pub. No.: US 2022/0290962 A1
(43) Pub. Date: Sep. 15, 2022

(54) SYSTEMS AND METHODS FOR SIMULATING BLAST EFFECTS OF AN EXPLOSIVE

(71) Applicant: Layer 3 Services PTY LTD, Fyshwick (AU)

(72) Inventors: Donald Williams, Carwoola (AU); David Wilson, Hoskinstown (AU)

(21) Appl. No.: 17/632,618

(22) PCT Filed: Jul. 31, 2020
(86) PCT No.: PCT/AU2020/050791

§ 371 Date: Feb. 3, 2022

(30) Foreign Application Priority Data
Aug. 6, 2019 (AU) 2019902811

(51) Int. Cl. F42D 99/00; F41A 33/00; G09B 9/00; G08C 17/02

(52) U.S. Cl. CPC F42D 99/00; F41A 33/00; G09B 9/003; G08C 17/02

(57) ABSTRACT

An explosion simulation system for simulating blast effects of an explosive device includes a transmitting device connected to the explosive device to transmit a virtual radio frequency blast wave upon activation; and attenuate the virtual radio frequency blast wave to match a mass of explosives used in the explosive device. The system also includes remote receiving devices comprising an audible alarm to indicate when the blast wave is received from the transmitting device. The receiving devices may get activated upon receiving the blast wave; calculate one or more effects of a blast of the explosive device by decoding the blast wave based on an explosive charge weight comprising a kg TNT equivalent of the explosive device, a distance, a peak incident pressure, a peak reflected pressure, and a peak reflected impulse; and display the effects of the blast in at least one category comprising an ear rupture threshold.

### TECHNICAL FIELD

The presently disclosed subject matter generally relates to the field of systems and methods for simulating an operation and effect of explosives or explosive weapons. Particularly, the present subject matter relates to systems and methods for simulating and replicating blast effects of an explosive such as, a bomb for military training exercises.

### BACKGROUND

Any references to methods, apparatus or documents of the prior art are not to be taken as constituting any evidence or admission that they formed, or form part of the common general knowledge.

In military, army, mining industry, etc. explosives are used for various purposes. The soldiers or people working in the army, mining industry etc. require proper training about explosive and explosive system so that they can use them in a safe and effective manner. Also, the people working in these industries need to understand the essential safety measures required for working in such environment. Any kind of carelessness while operating or handling explosives or explosive weapons may lead to fatal consequences.

One way of providing explosive device trainings is by showing videos of explosions or videos of handling the explosive devices. The video training may provide steps for initiating a blast, and requirements for doing a blast, and so forth. This may help the people to understand how the explosion happens and what measures need to be taken. But a video training may not be as realistic as an actual explosion. Further, not only people directly involved with operating and handling explosive devices, or weapons should be trained, but other people working in that area should also be trained as the effects of the explosion, like blast intensity, noise etc. can affect other people and surroundings too. For example, if the other people are within a range of a blast site, the blast can be heard by them and sometimes the blast intensity may be like it can break glasses, can rupture eardrum of the other people etc. Further, it's not always possible to train the people with actual explosive devices due to their unsafe nature and cost involved.

In light of the above, it's evident that technologies haven't be implemented successfully and thoroughly into simulation systems for explosions and current systems for simulating effects of explosives is empirical and limited. Therefore, there exists a need for improved techniques for replicating or simulating effects of blast waves. It is an object of the present disclosure to overcome or ameliorate the above discussed disadvantages of the prior art, or at least offer a useful alternative.

### SUMMARY

An object of the present disclosure is to provide a simulation system and method for replicating an operation and effects of explosives and explosive weapons like a bomb. The simulation system and method are designed to simulate an extent and pressure of blast waves (or blast eave signals) by ‘dialling in’ predetermined amounts of explosive using medium of radio frequency (RF). The system is portable and battery operated.

An embodiment of the present disclosure provides a system for simulating blast effects of an explosive device. The system includes an explosion simulation system including a transmitting device connected to the explosive device. The transmitting device is configured to transmit a virtual radio frequency (RF) blast wave upon activation, wherein the virtual radio frequency blast wave comprises a free-to-air 2.4 Gigahertz (GHz) Wi-Fi protocol. The transmitting device may be further configured to modify or adapt the virtual radio frequency blast wave to include properties or characteristics of the blast. The modification or adaption may include attenuation of the virtual radio frequency blast wave to match a mass of explosives used in the explosive device. The explosion simulation system further includes one or more remote receiving devices comprising an audible alarm configured to indicate when the virtual radio frequency blast wave is received from the transmitting device. The one or more receiving devices are configured to: get activated upon receiving the virtual radio frequency blast wave from the transmitting device; calculate one or more effects of a blast of the explosive device by decoding the virtual radio frequency (RF) blast wave based on an explosive charge weight (W) comprising a kg TNT equivalent of the explosive device, a distance (D), a peak incident pressure (Pi), a peak reflected pressure (Pr), and a peak reflected impulse (Rimp); and display the one or more effects of the blast in at least one category comprising an ear rupture threshold.

According to an aspect of the present disclosure, the explosive device may comprise an improvised explosive device (IED)

According to another aspect of the present disclosure, the explosion simulation system may further include at least five low gain antennas, one unity gain antenna, a 240V to 9V direct current plug pack and a simulated IED trigger device for training situation in which the powered explosive device is unavailable.

According to another aspect of the present disclosure, the virtual RF blast wave includes a blast wave that would have been generated by an actual explosion of the explosive device.

According to another aspect of the present disclosure, the one or more receiving devices may calculate the one or more effects of the blast based on an assumption that the blast wave strikes a target surface at 90 degrees.

According to another aspect of the present disclosure, the peak incident pressure (Pi) may be a pressure experienced if the blast wave travelled across the target surface and a force was applied ‘side on’, wherein the peak reflected pressure (Pr) may be a pressure that continues to build until it reaches a point of reflection if the surface not fail, the peak reflected pressure (Pr) being a maximum pressure expected to be experienced by the target surface, further wherein the peak reflected impulse (Rimp) may be the pressure applied over a period of time assuming that the target surface does not fail before the peak reflected impulse is achieved.

According to another aspect of the present disclosure, the one or more receiving devices are configured to display the one or more effects of the blast in at least one category including, but not limited to, a glass breakage threshold, the ear rupture threshold, and a blast lung threshold.

According to another aspect of the present disclosure, the one or more receiving devices includes one or more light emitting diode (LED) indicators for displaying the one or more effects of the blast for the at least one category.

According to another aspect of the present disclosure, the transmitting device may be configured to transmit a frequency that passes through a glass and thin walls but has some degree of reflection/attenuation by solid walls.

According to another aspect of the present disclosure, the transmitting device may further include a power on/off key switch for switching on and switching off the transmitting device; one or more push button switches for providing one or more functions. The one or more functions may include such as, but not limited to, an enter, a set, a status, a previous, a decrement, a next, an increment function.

In some embodiments, the transmitting device may also include at least two lines with twenty-character display showing a system set-up and a status; a pair of first binding posts configured to connect to the explosive device comprising an IED trigger output; a pair of second binding posts connects in parallel to the pair of first binding posts acting as a ‘loop through’ to connect to the transmitting device; and a menu driven user interface for allowing a user to vary a TNT equivalent charge weights, and a menu driven status page.

According to another aspect of the present disclosure, the transmitting device is further configured to burst transmission of the blast wave with error detection and an automatic retry.

According to another aspect of the present disclosure, the transmitting device and the one or more receiving devices are environment resistant and are configured to operate in different environmental conditions.

According to another aspect of the present disclosure, the transmitting device and the one or more receiving devices are portable and battery operated.

Another embodiment of the present disclosure provides an explosion simulation system including a transmitting device connected to an explosive device comprising an improvised explosive device (IED) The transmitting device is configured to transmit a virtual radio frequency blast wave upon activation, wherein the virtual radio frequency blast wave comprises a free-to-air 2.4 Gigahertz (GHz) Wi-Fi protocol. The transmitting device is further configured to attenuate the virtual radio frequency blast wave to match a mass of notional explosives used in the explosive device. The explosion simulation system also includes one or more remote receiving devices comprising an audible alarm configured to indicate when the virtual radio frequency blast wave is received from the transmitting device. The one or more receiving devices are configured to: get activated upon receiving the virtual radio frequency blast wave from the transmitting device; calculate one or more effects of a blast of the explosive device by decoding the virtual RF blast wave based on an explosive charge weight (W) comprising a kg TNT equivalent of the explosive device, a distance (D), a peak incident pressure (Pi), a peak reflected pressure (Pr), and a peak reflected impulse (Rimp); and display the one or more effects of the blast in at least one category comprising an ear rupture threshold, a glass breakage threshold, and a blast lung threshold. The system also includes a plurality of low gain antennas, one unity gain antenna, a 240V to 9V direct current plug pack and a simulated TED trigger device for training situation in which the powered explosive device is unavailable.

According to an aspect of the present disclosure, the virtual radio frequency blast wave comprises a blast wave that would have been generated by an actual explosion of the explosive device.

According to another aspect of the present disclosure, the one or more receiving devices includes the one or more effects of the blast based on an assumption that the blast wave strikes a target surface at 90 degrees.

Further, in some embodiments, the one or more receiving devices comprises one or more light emitting diode indicators for displaying the one or more effects of the blast in at least one category.

According to another aspect of the present disclosure, the peak incident pressure (Pi) being a pressure experienced if the blast wave travelled across the target surface and a force was applied ‘side on’.

In some embodiments, the peak reflected pressure (Pr) may be a pressure that continues to build until it reaches a point of reflection if the surface not fail.

Further, the peak reflected pressure (Pr) may be a maximum pressure expected to be experienced by the target surface.

In some embodiments, the peak reflected impulse (Rimp) being the pressure applied over a period of time assuming that the target surface does not fail before the Rimp is achieved.

According to another aspect of the present disclosure, the transmitting device may further be configured to transmit a frequency that passes through a glass and thin walls but has some degree of reflection/attenuation by solid walls.

According to another aspect of the present disclosure, the transmitting device may further be configured to burst transmission of the blast wave with error detection and an automatic retry.

According to another aspect of the present disclosure, the transmitting device of the explosion simulation system may further include a power on/off key switch for switching on and switching off the transmitting device; one or more push button switches for providing an enter, a set, a status, a previous, a decrement, a next, an increment functions; at least two lines with twenty-character display showing a system set-up and a status; a pair of first binding posts configured to connect to the explosive device comprising an IED trigger output; a pair of second binding posts connects in parallel to the pair of first binding posts acting as a ‘loop through’ to connect to the transmitting device; and a menu driven user interface for allowing a user to vary a TNT equivalent charge weights, and a menu driven status pages.

According to another aspect of the present disclosure, the transmitting device and the one or more receiving devices are environment resistant and are configured to operate in different environmental conditions.

In some embodiments, the transmitting device and the one or more receiving devices are portable and battery operated.

Another embodiment of the present disclosure provides a method for simulating blast effects of an explosive device. The method includes transmitting, by a transmitting device connected to the explosive device, a virtual radio frequency blast wave upon activation, wherein the virtual radio frequency blast wave comprises a free-to-air 2.4 Gigahertz (GHz) Wi-Fi protocol, wherein the virtual radio frequency blast wave is attenuated to match a mass of explosives used in the explosive device. The method also includes providing one or more remote receiving devices comprising an audible alarm configured to indicate when the virtual radio frequency blast wave is received from the transmitting device. The one or more remote receiving devices are configured to: get activated upon receiving the virtual radio frequency blast wave from the transmitting device; calculate one or more effects of a blast of the explosive device by decoding the virtual RF blast wave based on an explosive charge weight (W) comprising a kg TNT equivalent of the explosive device, a distance (D), a peak incident pressure (Pi), a peak reflected pressure (Pr), and a peak reflected impulse (Rimp); and display the one or more effects of the blast in at least one category comprising an ear rupture threshold.

According to another aspect of the present disclosure, the explosive device comprises an improvised explosive device (TED) In some embodiments, the virtual radio frequency blast wave comprises a blast wave that would have been generated by an actual explosion of the explosive device.

According to another aspect of the present disclosure, the one or more effects of the blast are calculated based on an assumption that the blast wave strikes a target surface at 90 degrees.

According to another aspect of the present disclosure, the peak incident pressure (Pi) being a pressure experienced if the blast wave travelled across the target surface and a force was applied ‘side on’. The peak reflected pressure (Pr) may be a pressure that continues to build until it reaches a point of reflection if the surface not fail, the peak reflected pressure (Pr) may be a maximum pressure expected to be experienced by the target surface. The peak reflected impulse (Rimp) may be the pressure applied over a period of time assuming that the target surface does not fail before the Rimp is achieved.

According to another aspect of the present disclosure, the method may also include displaying, by the one or more receiving devices, the one or more effects of the blast in at least one category comprising a glass breakage threshold, the ear rupture threshold, and a blast lung threshold.

According to another aspect of the present disclosure, the method may also include displaying, by the one or more receiving devices, the one or more effects of the blast in at least one category via one or more light emitting diode (LED) indicators of the one or more receiving devices.

According to another aspect of the present disclosure, the method may also comprise transmitting, by the transmitting device, a frequency that passes through a glass and thin walls but has some degree of reflection/attenuation by solid walls.

According to another aspect of the present disclosure, the method may also include providing at least five low gain antennas, one unity gain antenna, a 240V to 9V direct current plug pack and a simulated improvised explosive device trigger device for training situation in which the powered explosive device is unavailable.

### DETAILED DESCRIPTION

Preferred features, embodiments and variations of the invention may be discerned from the following detailed description which provides sufficient information for those skilled in the art to perform the invention. The detailed description is not to be regarded as limiting the scope of the preceding summary of the invention in any way.

The functional units described in this specification have been labelled as devices or modules. A device or module may be implemented in programmable hardware devices such as CPUs, electronic devices, tensor processors, field programmable gate arrays (FPGA), cloud computation units, distributed computation units, or the like. The devices and modules may also be implemented in software for execution by various types of processors. An identified device or module may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Furthermore, the described features, structures, or characteristics may be combined in any suitable manner in one or more embodiments.

Specific embodiments of the present invention are described, by way of example only, with reference to the accompanying drawings, in which:

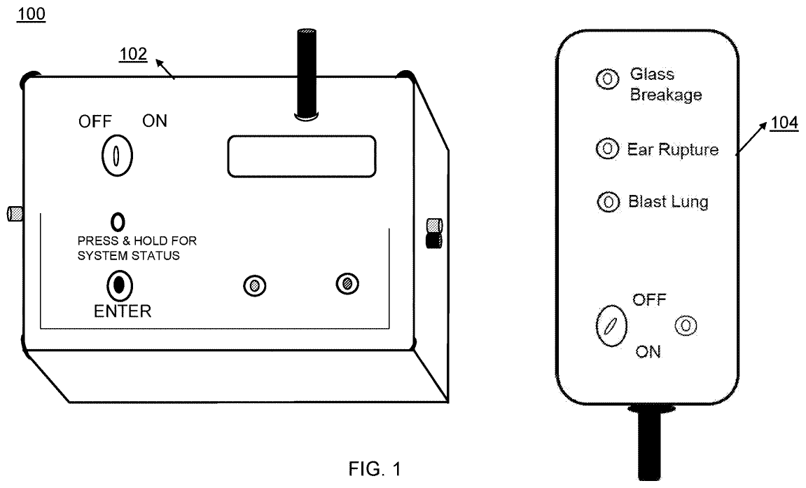

FIG. 1 is a schematic diagram illustrating an exemplary explosion simulation system 100, in accordance with an embodiment of the present disclosure;

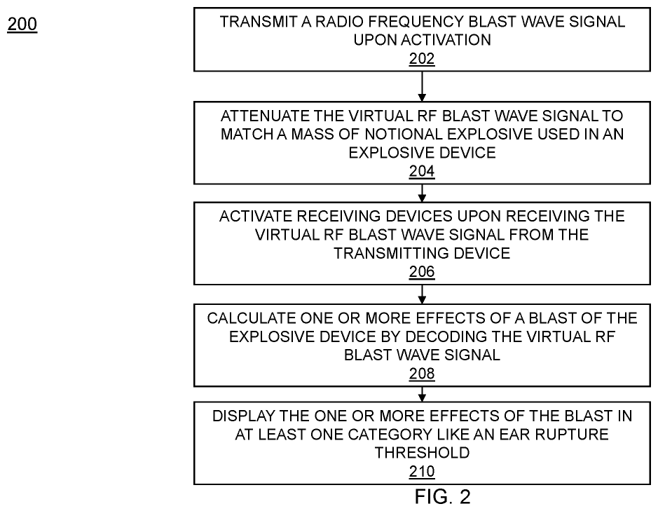

FIG. 2 is a flowchart diagram illustrating an exemplary method 200 for simulating blast effects of an explosive device, in accordance with an embodiment of the present disclosure;

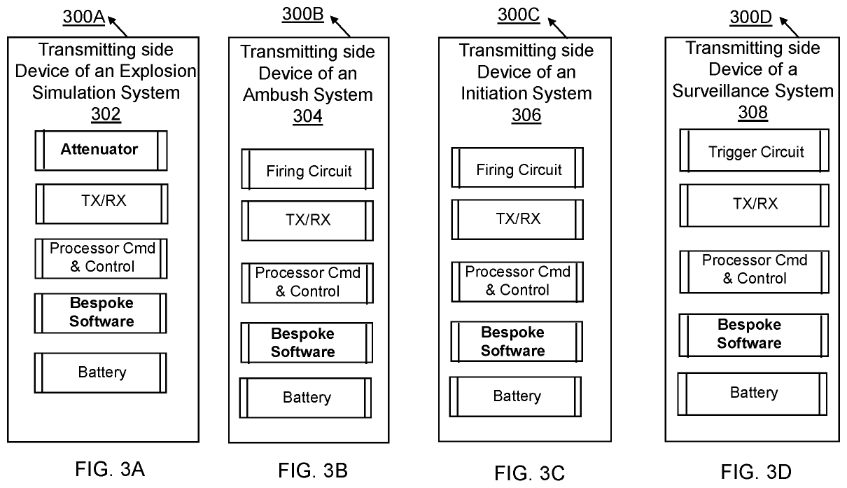

FIG. 3A is a block diagram 300A illustrating various system elements of a transmitting side device 302 of an explosion simulation system, in accordance with an embodiment of the present disclosure;

FIG. 3B is a block diagram 300B illustrating various system elements of a transmitting side device 304 of an ambush system, in accordance with an embodiment of the present disclosure;

FIG. 3C is a block diagram 300C illustrating various system elements of a transmitting side device 306 of an initiation system, in accordance with an embodiment of the present disclosure;

FIG. 3D is a block diagram 300D illustrating various system elements of a transmitting side device 308 of a surveillance system, in accordance with an embodiment of the present disclosure;

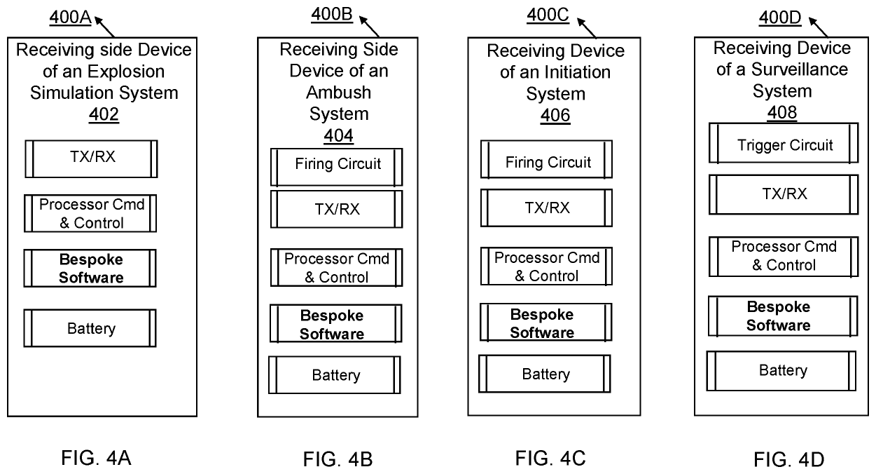

FIG. 4A is a block diagram 400A illustrating various system elements of a receiving side device 402 of an explosion simulation system, in accordance with an embodiment of the present disclosure;

FIG. 4B is a block diagram 400B illustrating various system elements of a receiving side device 404 of an ambush system, in accordance with an embodiment of the present disclosure;

FIG. 4C is a block diagram 400C illustrating various system elements of a receiving side device 406 of an initiation system, in accordance with an embodiment of the present disclosure;

FIG. 4D is a block diagram 400D illustrating various system elements of a receiving side device 408 of a surveillance system, in accordance with an embodiment of the present disclosure;

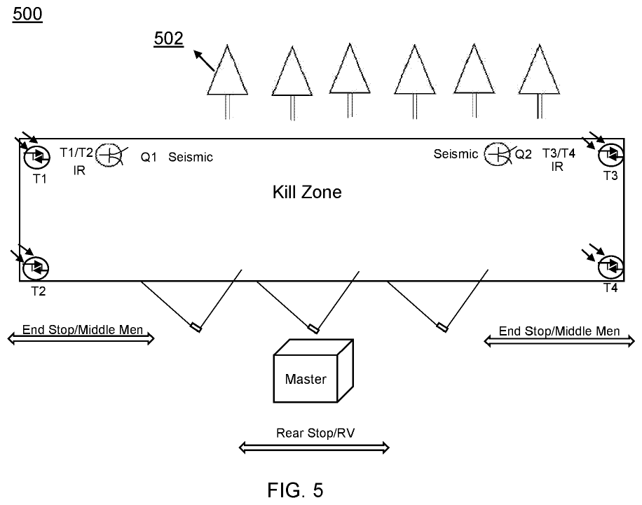

FIG. 5 illustrates an exemplary environment 500 where an ambush system can be used, in accordance with an embodiment of the present disclosure;

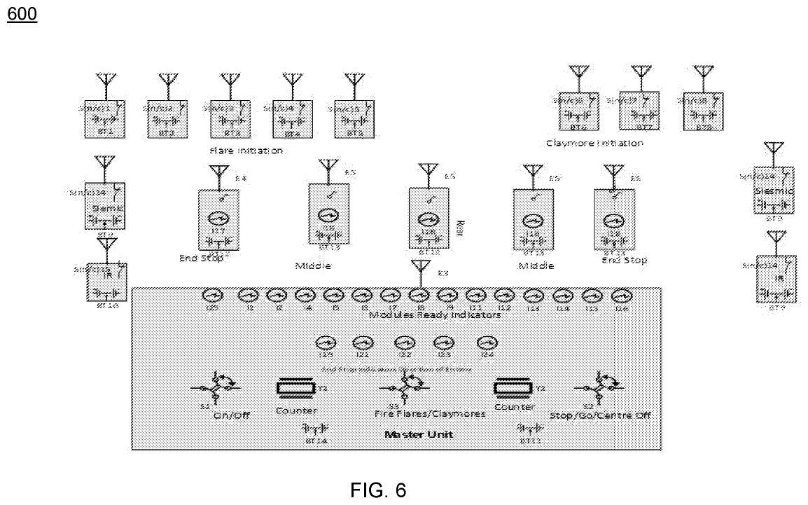

FIG. 6 illustrates an exemplary modules circuit board 600 including a master unit and modules of the ambush system can be used, in accordance with an embodiment of the present disclosure;

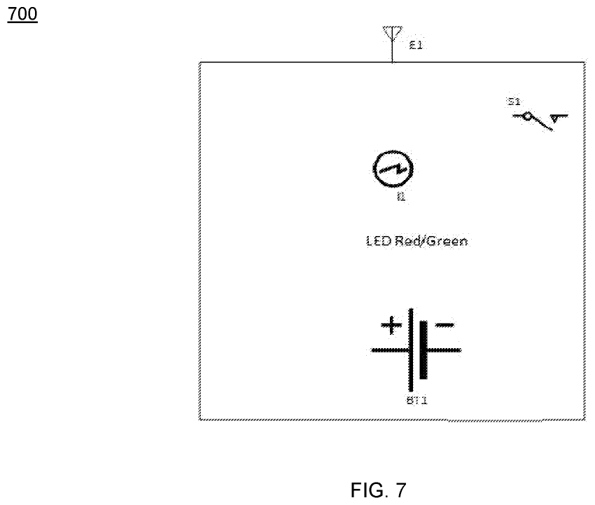

FIG. 7 illustrates an end stop module diagram 700 of the ambush system, in accordance with an embodiment of the present disclosure;

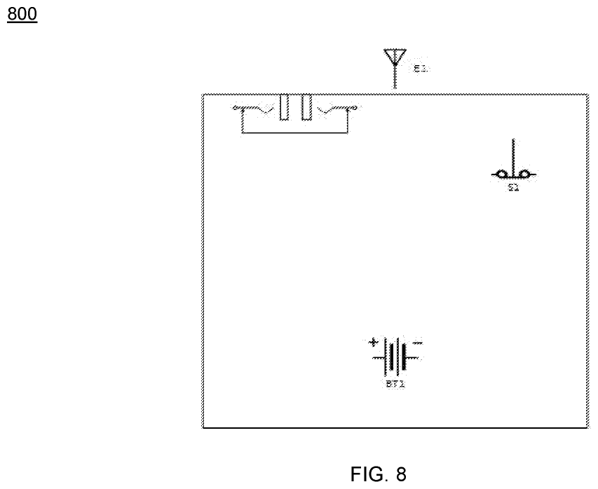

FIG. 8 illustrates a flare/mine module diagram 800 of the ambush system, in accordance with an embodiment of the present disclosure;

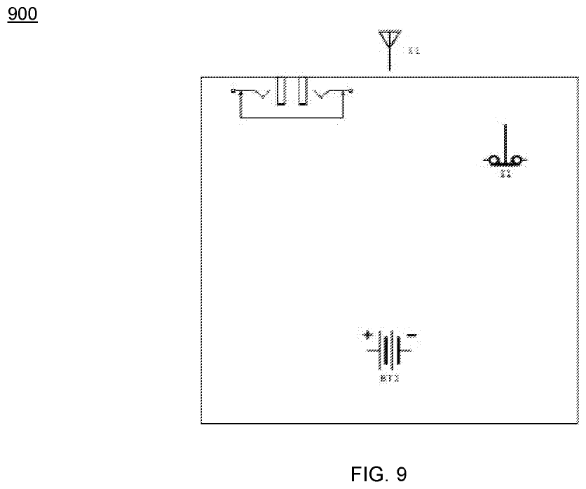

FIG. 9 illustrates a seismic detector module diagram 900 of the ambush system, in accordance with an embodiment of the present disclosure;

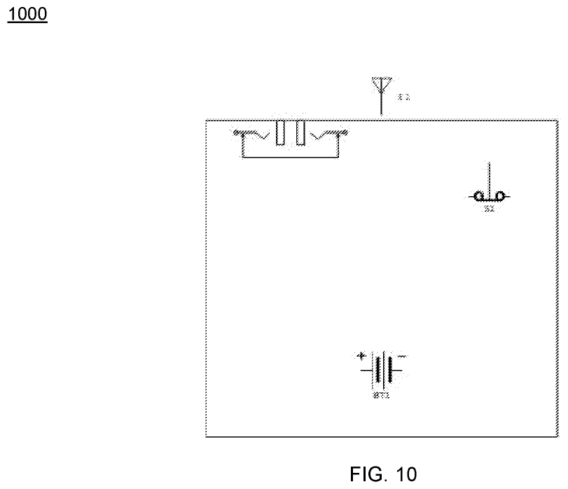

FIG. 10 illustrates an infrared module diagram 1000 of the ambush system, in accordance with an embodiment of the present disclosure;

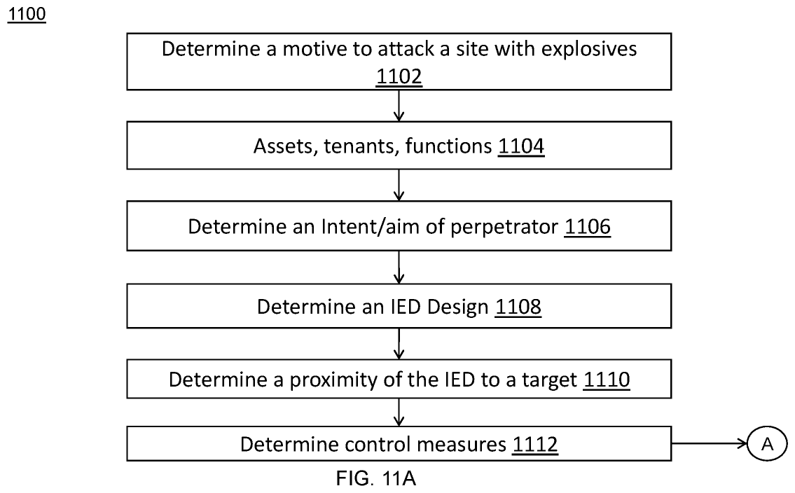

FIGS. 11A-11B is a flowchart diagram illustrating a blast assessment method 1100, in accordance with an embodiment of the present disclosure;

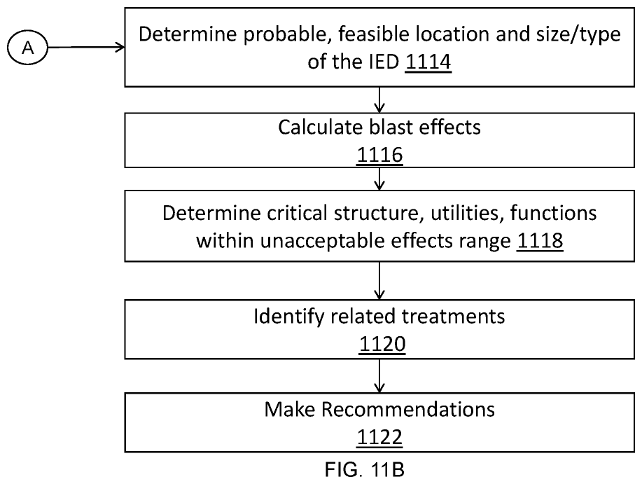

FIG. 12 illustrates a firing circuit diagram 1200 of an exemplary initiator of an initiation system, in accordance with an embodiment of the present disclosure; and

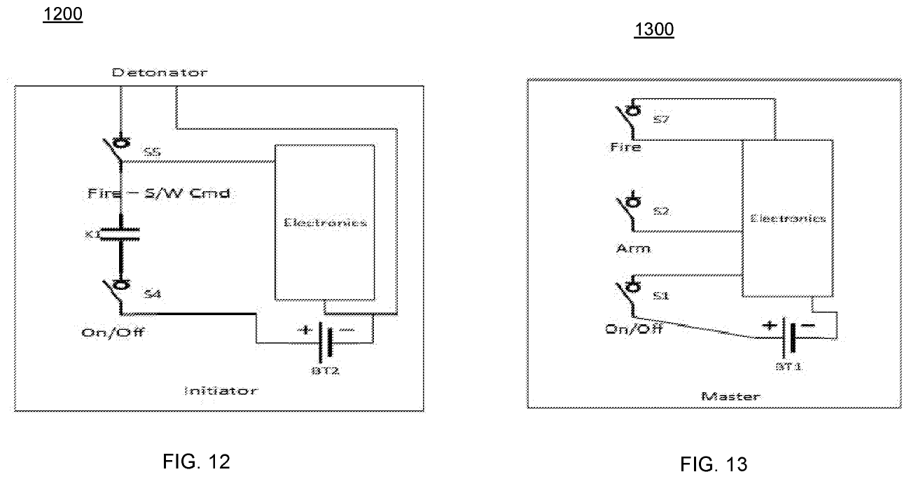

FIG. 13 illustrates a firing circuit diagram 1300 of an exemplary master unit of the initiation system, in accordance with an embodiment of the present disclosure.

Referring to FIG. 1, the exemplary explosion simulation system 100 is shown, in accordance with an embodiment of the present disclosure. The explosion simulation system 100 is configured for simulating blast effects of an explosive device such as, but not limited to, a bomb. In some embodiments, the explosion simulation system 100 may be a Wi-Fi based system. In alternative embodiments, the explosion simulation system 100 is a radio frequency (RF) based system. The explosion simulation system 100 is configured to simulate an extent and pressure of blast waves by ‘dialling in’ predetermined amounts of explosive using a medium range of radio frequency or Wi-Fi. The explosion simulation system 100 is portable and battery powered. A Master unit of the explosion simulation system 100 is a ‘detonator’ 102, i.e. a transmitting device 102, which, when activated, initiates the RF signal which in turn activates (or not) the remote units i.e. one or more receiving devices. The remote units cannot be deactivated by the wearer. The remote units may be worn by students (the people being trained) or placed in critical locations.

The transmitting device 102 (hereinafter, may also be referred as a detonator 102 without change in its meaning) is connected to an explosive device like an improvised explosive device (IED) The transmitting device 102 is configured to transmit a virtual radio frequency (RF) blast wave (hereinafter, may also be referred as a blast wave signal without change in its meaning) upon activation. In some embodiments, the virtual RF blast wave includes a free-to-air 2.4 Gigahertz (GHz) Wi-Fi. In some embodiments, the virtual RF blast wave may include a blast wave that would have been generated by an actual explosion of the explosive device. In some embodiments, the explosive device may include an improvised explosive device (IED)

The transmitting device 102 is further configured to attenuate the virtual radio frequency (RF) blast wave to match a mass of notional explosives used in the explosive device. In some embodiments, the transmitting device 102 attenuates the virtual radio frequency (RF) blast wave to match the mass of the notional explosive used for example, 5, 10, 20, 25, 50 and 100 Kg.

In some embodiments, the transmitting device 102 is configured to transmit a frequency that passes through a glass and thin walls but has some degree of reflection/attenuation by solid walls. Further, the transmitting device 102 may be configured to burst transmission of the blast wave with error detection and an automatic retry.

The transmitting device 102 further includes a power on/off key switch for switching on and switching off the transmitting device, and one or more push button switches for providing an enter, a set, a status, a previous, a decrement, a next, and an increment function. Further, the transmitting device 102 includes at least two lines with twenty-character display showing a system set-up and a status, a pair of first binding posts may be configured to connect to the explosive device including an TED trigger output, a pair of second binding posts connected in parallel to the pair of first binding posts acting as a ‘loop through’ to connect to the transmitting device, and a menu driven user interface for allowing a user to vary a TNT equivalent charge weights, and a menu driven status pages.

The explosion simulation system 100 also includes a receiving device 104. In some embodiments, the explosion simulation system 100 may include one or more receiving devices similar to the receiving device 104. The receiving device 104 includes an audible alarm to indicate when the virtual radio frequency (RF) blast wave is received from the transmitting device 102. The receiving device 104 gets activated upon receiving the virtual RF blast wave (or blast wave signal) from the transmitting device 102.

Further, the receiving device 104 is configured to calculate one or more effects of a blast of the explosive device by decoding the virtual RF blast wave signal based on an explosive charge weight (W) comprising a kg TNT equivalent of the explosive device, a distance (D), a peak incident pressure (Pi), a peak reflected pressure (Pr), and a peak reflected impulse (Rimp). The peak incident pressure (Pi) being a pressure experienced if the blast wave travelled across the target surface and a force was applied ‘side on’. The peak reflected pressure (Pr) being a pressure that may continue to build until it reaches a point of reflection if the target surface not fail. The peak reflected pressure (Pr) being a maximum pressure expected to be experienced by the target surface. The peak reflected impulse (Rimp) being the pressure applied over a period of time assuming that the target surface does not fail before the Rimp is achieved.

The receiving device 104 (or the one or more receiving devices) may calculate the one or more effects of the blast based on an assumption that the blast wave strikes a target surface at 90 degrees.

The receiving device 104 is configured to display the one or more effects of the blast in at least one category including an ear rupture threshold. In some embodiments, the receiving device 104 is configured to display the one or more effects of the blast in at least one category including such as, but not limited to, the ear rupture threshold, a glass breakage threshold, the ear rupture threshold, and a blast lung threshold. In some embodiments, the receiving device 104 (or the one or more receiving devices) includes one or more light emitting diode (LED) indicators for displaying the one or more effects of the blast for the at least one category.

In some embodiments, the explosion simulation system 100 includes a housing including at least five low gain antennas, one unity gain antenna, a 240V to 9V direct current plug pack and a simulated IED trigger device for training situation in which the powered explosive device is unavailable.

The transmitting device 102 and the receiving device 104 is environment resistant and are configured to operate in different environmental conditions. Further in some embodiments, the transmitting device 102 and the receiving device 104 is portable and battery operated.

Referring to the FIG. 2, the flowchart diagram illustrating the exemplary method 200 for simulating blast effects of the explosive device is shown, in accordance with an embodiment of the present disclosure. At step 202, a transmitting device like the transmitting device 102 as discussed with reference to FIG. 1, transmits a radio frequency blast wave or a blast wave signal upon activation of the transmitting device 102.

At step 204, the transmitting device 102 attenuates the virtual RF blast wave (or blast wave signal) to match a mass of notional explosive used in an explosive device like IED. In some embodiments, the transmitting device 102 may attenuate the virtual radio frequency (RF) blast wave to match the mass of the notional explosive used for example, 5, 10, 20, 25, 50 and 100 Kg. For example, the transmitting device 102 may attenuate the blast wave signal at a rate of 50 Ohm. The non-limiting examples of the explosives may include Acetylides of heavy metals, Aluminum containing polymeric propellant, Aluminum ophorite explosive, Amatex, Amatol, Baranol, Barotol, BEAF [1, 2-bis (2, 2-difluoro-2-nitroacetoxyethane)], Black powder, Black powder based explosive mixtures, Blasting agents, nitro-carbo-nitrates, including non-cap sensitive slurry and water gel explosives, Calcium nitrate explosive mixture, Cellulose hexanitrate explosive mixture, Chlorate explosive mixtures, Composition A and variations, Composition B and variations, Composition C and variations, Dipicrylamine, Display fireworks, EDNP [ethyl 4,4-dinitropentanoate], EGDN [ethylene glycol dinitrate], and Erythritol tetranitrate explosives.

At step 206, the receiving device 104 or the one or more receiving devices gets activated upon receiving the virtual RF blast wave from the transmitting device 102. At step 208, the receiving device 104 calculates one or more effects of a blast of the explosive device by decoding the virtual RF blast wave. In some embodiments, the blast blast effects calculations are conducted by the receiving device 104 using the model provided in US Army Technical Manual 5-855-1 ‘Fundamentals for protective design for conventional weapons’.

In some embodiments, the receiving device 104 is configured to calculate one or more effects of a blast of the explosive device by decoding the virtual RF blast wave based on an explosive charge weight (W) comprising a kg TNT equivalent of the explosive device, a distance (D), a peak incident pressure (Pi), a peak reflected pressure (Pr), and a peak reflected impulse (Rimp). The peak incident pressure (Pi) measured in kPa, may be a pressure experienced if the blast wave travelled across the target surface and a force was applied ‘side on’. The peak reflected pressure (Pr) measured in kPa may be a pressure that continues to build until it reaches a point of reflection if the surface not fail. The peak reflected pressure (Pr) may be a maximum pressure expected to be experienced by the target surface. The peak reflected impulse (Rimp) measured in kPa-msec, may be the pressure applied over a period of time assuming that the target surface does not fail before the Rimp is achieved. The Rimp assumes that the target surface does not fail before the Rimp is achieved. Similarly, the Pr assumes that the target surface does not fail before the Pr is achieved.

In some embodiments, the receiving device 104 (or the one or more receiving devices) may calculate the one or more effects of the blast based on an assumption that the blast wave strikes a target surface at 90 degrees.

At step 210, the receiving device(s) 104 displays the one or more effects of the blast in at least one category like an ear rupture threshold. In some embodiments, the receiving device 104 displays the one or more effects of the blast in categories like, but not limited to, a glass breakage threshold, the ear rupture threshold, and a blast lung injury depending on a distance from the source of blast and a magnitude of the blast. The receiving device 104 may include alarm and/or LED indicators for displaying the one or more effects of the blast. For example, the receiving device 104 includes 3 LED indicators for displaying the one or more blast effects for each of the three categories i.e. the glass breakage threshold, the ear rupture threshold, and the blast lung injury. The LED indictors may turn on or blink to display the one or more effects of the blast.

Referring to the FIG. 3A, the block diagram 300A illustrating various system elements of the transmitting side device 302 of the explosion simulation system is shown. As shown, the transmitting side device 302 of the explosion simulation system includes an attenuator, a transmitter/receiver module, a processor command and control module, a bespoke software, and at least one battery. The attenuator is configured to attenuate a virtual RF blast wave to match a mass of notional explosive used in an explosive device like IED. In some embodiments, the attenuator of the transmitting side device 302 attenuates the virtual radio frequency (RF) blast wave to match the mass of the notional explosive used for example, 5, 10, 20, 25, 50 and 100 Kg. In some embodiments, at least one battery may be a replaceable 9V alkaline battery to allow days of continuous operation. In some embodiments, the at least one battery is rechargeable battery and may be charged using a power-able DC power source. The at least one battery may include 6 replaceable C-cell alkaline batteries. The modules of the transmitting side device 302 may include software, hardware, firmware or combination of these.

Referring to the FIG. 3B, the block diagram 300B illustrating various system elements of the transmitting side device 304 of the ambush system is shown. The transmitting side device 304 of the ambush system includes a firing circuit, a transmitter/receiver module, a processor command (Cmd) and control module, a bespoke software module (custom software), at least one battery. In some embodiments, at least one battery may be a replaceable 9V alkaline battery to allow days of continuous operation. In some embodiments, the at least one battery is rechargeable battery and may be charged using a power-able DC power source. The at least one battery may include 6 replaceable C-cell alkaline batteries. The modules of the transmitting side device 304 may include software, hardware, firmware or combination of these.

Referring to the FIG. 3C, the block diagram 300C illustrating various system elements of the transmitting side device 306 of the initiation system is shown. The transmitting side device 304 of the initiation system includes a firing circuit, a transmitter/receiver module, a processor command (Cmd) and control module, a bespoke software module, at least one battery. In some embodiments, at least one battery may be a replaceable 9V alkaline battery to allow days of continuous operation. In some embodiments, the at least one battery is rechargeable battery and may be charged using a power-able DC power source. The at least one battery may include 6 replaceable C-cell alkaline batteries. The modules of the transmitting side device 306 may include software, hardware, firmware or combination of these.

The initiation system may provide an initial energy required to detonate an explosive used for rock blasting. The initiation system may require: an initial energy source, a distribution network to deliver the energy to each blasthole or explosive device, and an in-hole component to initiate a detonator-sensitive explosive. Detonators are devices used to initiate high explosives. A detonator is a complete explosive initiation device that includes the active part of the assembly (usually enclosed in a metal shell) and the attached initiation signal transmitter (for example, leg wires, a shock tube, or other signal-transmitting material). The detonators may be either instantaneous (no time-delay element), millisecond (ms) delay, or long-period delay. The millisecond delay detonators may be used for surface-mine blasting and can be manufactured with delay times up to 500 ms. The long-period delay detonators are available for periods up to several seconds.

Referring to the FIG. 3D, the block diagram 300D illustrating various system elements of the transmitting side device 308 of the surveillance system is shown. The transmitting side device 304 of the surveillance system includes a trigger circuit, a transmitter/receiver module, a processor command (Cmd) and control module, a bespoke software module, at least one battery. In some embodiments, at least one battery may be a replaceable 9V alkaline battery to allow days of continuous operation. In some embodiments, the at least one battery is rechargeable battery and may be charged using a power-able DC power source. The at least one battery may include 6 replaceable C-cell alkaline batteries. In some embodiments, the surveillance kit or system also includes a still camera or video camera for surveillance. The modules of the transmitting side device 308 may include software, hardware, firmware or combination of these.

Referring to the FIG. 4A, the block diagram 400A illustrating various system elements of the receiving side device 402 of the explosion simulation system is shown. The explosion simulation system in similar in structure and function to the explosion simulation system 100 as discussed with reference to the FIG. 1. In some embodiments, the explosion simulation system may be a Wi-Fi based system. In alternative embodiments, the explosion simulation system is a radio frequency (RF) based system. As shown, the receiving side device 402 of the explosion simulation system includes a transmitter/receiver module, a processor command (Cmd) and control module, a bespoke software, and at least one battery. In some embodiments, at least one battery may be a replaceable 9V alkaline battery to allow days of continuous operation. In some embodiments, the at least one battery is rechargeable battery and may be charged using a power-able DC power source. The at least one battery may include 6 replaceable C-cell alkaline batteries. The modules of the receiving side device 402 may include software, hardware, firmware or combination of these.

Referring to the FIG. 4B, the block diagram 400B illustrating various system elements of the receiving side device 404 of the ambush system is shown. As shown, the receiving side device 404 of the ambush system includes a firing circuit, a transmitter/receiver module, a processor command (Cmd) and control module, a bespoke software, and at least one battery. In some embodiments, at least one battery may be a replaceable 9V alkaline battery to allow days of continuous operation. The modules of the receiving side device 404 may include software, hardware, firmware or combination of these.

Referring to the FIG. 4C, the block diagram 400C illustrating various system elements of the receiving side device 406 of the initiation system is shown. As shown, the receiving side device 406 of the initiation system includes a firing circuit, a transmitter/receiver module, a processor command (Cmd) and control module, a bespoke software, and at least one battery. In some embodiments, at least one battery may be a replaceable 9V alkaline battery to allow days of continuous operation. The modules of the receiving side device 406 may include software, hardware, firmware or combination of these.

Referring to the FIG. 4D, the block diagram 400D illustrating various system elements of the receiving side device 408 of the surveillance system is shown. As shown, the receiving side device 408 of the surveillance system includes a trigger circuit, a transmitter/receiver module, a processor command (Cmd) and control module, a bespoke software, and at least one battery. In some embodiments, at least one battery may be a replaceable 9V alkaline battery to allow days of continuous operation. The surveillance kit or system also includes a still camera or video camera for surveillance. The modules of the receiving side device 408 may include software, hardware, firmware or combination of these.

Referring to the FIG. 5, the exemplary environment 500 where an ambush system can be used is shown. The ambush system may be a radio frequency (RF) based system designed to give an ambush commander warning and direction of an enemy and to provide command and control when the ambush is set. The ambush system may include a control module, one or more detection modules (e.g. seismic, IR, visual and audio sensors or detection modules), one or more basic communication modules for team members (like army soldiers), and firing circuit initiators for one or more flares 502 and mines. The ambush system is lightweight and small. In the FIG. 5, the bushy topped trees represent the flares 502.

In some embodiments, the ambush system uses off the shelf mobile phone batteries for power. In some embodiments, the ambush system may require supplementary, external, power sources (standby batteries) if exceptional drain is anticipated i.e. for the extensive initiation of flares, blasting caps, detonators, IR and seismic sensors.

The radio frequency (RF) based ambush system includes a control module configured to provide a command and control when an ambush is set. The RF based ambush system also includes one or more detection modules configured to detect one or more ambushes. The RF based ambush system also includes one or more communication modules for team members the one or more communication modules are configured to give an ambush commander warning and a direction of an enemy. The RF based ambush system also includes one or more firing circuit indicators for flares and mines and an ARM switch. Further, the RF based ambush system also includes a Wi-Fi unit/module configured to be programmed and enable at least two ambush systems to operate in close proximity without mutual interference.

Common design considerations for designing the ambush system includes that there is a need for a short-range wireless communications kit to co-ordinate and control sub-unit ambushes and area surveillance tasks. This may be based on 2.4 GHz Wi Fi. Further, all modules may be (or must be) pocket sized, lightweight, ruggedized and simple to use in all operating conditions of ambient light, temperature, humidity, rain and snow and should be designed for the NATO Temperature Range of: Commercial: 0° C. to 85° C.; Industrial: −40° C. to 100° C.; Automotive: −40° C. to 125° C.; Extended: −40° C. to 125° C.; Military: −55° C. to 125° C.

The ambush system is noiseless when activated. The flares and mines may be initiated in accordance with DoS (Denial of Service) safety parameters. Further, the ambush system has an endurance of 24 to 36 hours. Further, the ambush system is configured to communicate to the Ambush Commander/Team visually and/or audibly with volume and luminosity controls. Further, the ambush system is configured to receive and display input from sensing devices. The ambush system also includes a visual display such as, but not limited to, a light emitting diode (LED) and a liquid crystal display (LCD). Further, the ambush system is configured to be re-chargeable, and may have field battery replacement as an option. Further, the ambush system is configured to establish the MTBF (Mean Time Between Failures) and MTTR (Mean Time to Repair). The MTBF refers to an amount of time that elapses between one failure and the next failure. The MTBF may be calculated by adding MTTF (Mean Time to Failure) and the MTTR, i.e. the total time required for a device to fail and that failure to be repaired.

Further, the ambush system is configured to minimise outwards transmission (like RF transmissions) (LPI Low Probability of Intercept) automatically or manually.

The ambush system includes seismic detectors (hereinafter may also be referred as seismic detection modules) configured for detecting both vehicles and people. The ambush system also includes infrared (IR) detectors (hereinafter may also be referred as IR detection modules) for movement detection and counting.

Referring now to the FIG. 6, the exemplary modules circuit board 600 including a master unit and modules of the ambush system is shown. The modules circuit board 600 includes an USB port and simple drivers. The Wi Fi component is programmable and is thus a private Wi Fi network; this enables two systems to operate in close proximity without mutual interference.

All modules (1 to 17) have a capacity to reveal their status for example, ready or not ready to a Master Unit of a commander by means of coloured LED indicators. As discussed with reference to the FIG. 5, the LED are colour coded to differentiate between the Flares 502 and Mines initiators, IR and Seismic detectors, an End Stops module and a Middlemen. The modules require simple Tx/Rx (Transmit/receive) to the Master Unit.

Indicators 19 to 24 are triggered by the End Stops and the Middlemen module—the LEDs are activated by the modules and, by their sequential operation, indicate the direction of the enemy movement to the Commander.

S1 switches “on” the Master Unit. S2 is the “stop/go” signal for End Stops and Middlemen module that the ambush is set (Green) or to abort (Red). S3 is a ‘missile’ switch (i.e. a positive action is required to access the switch), which fires the flares 502 and the mines.

In some embodiments, the ambush system may also include an additional ARM switch

Referring to the FIG. 7, the end stop module diagram 700 of the ambush system is shown. The end stop module and middlemen may indicate via an LED red/green indicator, a passage of the enemy by operating a push button. They receive “go/abort” orders from the Master Unit via the LED.

Referring to the FIG. 8, the flare/mine module diagram 800 of the ambush system is illustrated, in accordance with an embodiment of the present disclosure. The flare/mine module is essentially the same as the end stop/middlemen module except that there are no LEDs and have terminals to connect the Flares or Mines. Each will have a unique ID.

Referring to the FIG. 9, the seismic detector module diagram 900 of the ambush system is shown, in accordance with an embodiment of the present disclosure. FIG. 10 illustrates the infrared module diagram 1000 of the ambush system, in accordance with an embodiment of the present disclosure. The IR and Seismic detection modules or detectors are like the operation of the Flare and Mine units. The ambush system includes the seismic detectors for detecting both vehicles and people. The ambush system also includes the infrared (IR) detectors (or IR detection modules) for movement detection and counting.

In some embodiments, the ambush system may also include a Platoon in Defence (PID) Kit configured for use in a defensive position occupied by approximately 30 men.

Referring to the FIGS. 11A-11B, the flowchart diagram illustrating the blast assessment method 1100 is shown, in accordance with an embodiment of the present disclosure. The method 1100 starts at 1102 where a type of an explosive device (or IED) and a motive to attack a site with explosives (or the explosive device) is determined. In some embodiments, the explosion simulation system determines the type of the explosive device (or IED) and the motive to attack a site with explosives. Further, a type of an explosive device is also determined. The size of the IED may dictate a type of explosive expected to be used. For smaller IEDs i.e. 20 kg or less, military, commercial grade explosives or low explosives' such as propellants are feasible. Pentolite is representative of common, commercially available high-velocity mining explosive and is used in the calculations. For larger IEDs i.e. greater than say 30 kg, Ammonium Nitrate/Fuel Oil (ANFO or AN/FO) or similar nitrate-based explosives are feasible, with associated booster charges.

At step 1104, it is determined if the IED is for use in assets, functions, or tenants. The improvised explosive device (IED) may be a bomb constructed and deployed in ways other than in conventional military action. Further, the IED may be constructed of conventional military explosives, such as an artillery shell, attached to a detonating mechanism. In some embodiments, the explosion simulation system determines if the IED is for use in assets, functions, or tenants.

Explosives may be procured, stolen, home-made explosives (HME), or provided by a third party. TNT (Trinitrotoluene) is used as the basis for explosive effect calculations and other explosives are measured against the well documented effects of TNT. The use of TNT as the explosive in an IED can lead to inappropriate findings. The explosive effort applied by ANFO is different to that of TNT in that ANFO is a blasting explosive that has a greater ‘pushing’ effect than TNT which has a ‘shattering’ effect. It is highly unlikely the perpetrators will use TNT as it is difficult to obtain other than during the manufacture of other explosives. In some embodiments, the selected charge weights are: for a PBIED 8.7 kg of Pentolite (10 kg TNT equivalent) and for a VBIED 225 kg of ANFO (225 kg TNT equivalent).

At step 1106, an intent or an aim of a perpetrator is determined. In some embodiments, the explosion simulation system determines the intent or aim of the perpetrator. Then at step 1108, an IED design for the explosive device is determined. For example, it may be decided if the IED is to be hand delivered, or is a suicidal bomb, or it's a person-borne improvised explosive device (PBIED), a vehicle-borne improvised explosive device (VBIED), a postal or courier bomb, a projected explosive device. In some embodiments, the explosion simulation system determines the IED design for the explosive device. The VBIED may be an improvised explosive device placed inside a car or other vehicle and then detonated. Examples of the VBIED may include a car bomb, lorry bomb, or truck bomb.

Now a location of the IED is determined. Then at step 1110, a proximity of the IED to a target is determined. In some embodiments, the explosion simulation system determines the proximity of the IED to the target. It is determined if the IED is an external explosive device like a VBIED, or hand carried to a facade (i.e. the target). It is also determined if the IED is an internal explosive e.g. PBIED, mail, postal, or internal car park, and so forth.

At step 1112, one or more control measures are determined. For example, a safe distance, access control, FoH, BoH, public, tenant areas, search capability, and so forth. In some embodiments, the explosion simulation system determines the control measures. Then at step 1114, a probable and feasible location and a size or type of the IED is determined.

All assumptions relating to IEDs are variable as it is not known what explosive will be used, how it will be primed or detonated, how it will be encased or where it will be placed. Security measures may restrict where the IED can be positioned. The following assumptions may be made in relation to the calculations: 1) the explosion is a ‘hemispherical ground burst’ i.e. charge is on or very close to the surface; 2) an angle of incidence is ‘normal’ i.e. at 90 degrees to the facade; 3) fragmentation effects may not be included.

In some embodiments, the following may be applied to determine minimum distances for the nominated charge weights: 1) 48 kPi (7 psi) that is given as the upper threshold for ‘severe damage to steel framed buildings’; 2) 690 kPa (100 psi) at which ‘Most construction materials will sustain major damage or failure at these peak pressure levels’.

Then at step 1116 blast effects are calculated. In some embodiments, the one or more receiving devices similar to the receiving device 104 of the explosion simulation system 100 as discussed with reference to the FIG. 1 calculates the blast effects. An explosion generates a blast wave (i.e. the virtual RF blast wave) that is assumed to strike a target surface at 90 degrees. The initial impact is a peak incident pressure (Pi) that is the same pressure experienced if the blast wave travelled across the surface and the force was applied side on. Should the surface not fail the pressure will continue to build until it reaches a point of reflection, the Peak Reflected pressure (Pr). This is the maximum pressure that is expected to be experienced by the surface. In addition, the pressure is applied over a period of time providing a peak reflected impulse (Rimp).

The important results when considering the ability of the structural elements to withstand an explosive event or an explosion are Pr and Rimp. The following may be used in the calculations:

W=Explosive charge weight (kg TNT equivalent)

D=Distance (m)

Rimp=peak reflected impulse (kPa-msec) assumes surface does not fail before Rimp is achieved

Pi=Peak incident pressure (kPa)

Pr=Peak reflected pressure (kPa) assumes surface does not fail before Pr is achieved.

The explosive charge weight (kg TNT equivalent) may be a weight of the explosive, excluding packaging and fragmentation casing, is referred to as net explosive quantity (NEQ) (ICAO 2008). Common NEQ used for blast calculations are: 23 kg/50 lb, 225 kg/500 lb, 500 kg, and 5000 kg. NEQ specified by governments as the basis for calculations tend to be classified, for example: UFC 4-010-02 is a restricted access document. UFC 4-010-2 is referenced by other US DoD and Federal Emergency Management Agency (FEMA) see US DoD 4-010-01 and FEMA 452 and 427. Wheeled bags of up to 23 kg are not unusual for visitors to hotels, areas frequented by backpackers or tenants.

A review of open source media reports on bombing incidents around the world as well as accessible official data suggests that most IEDs are less than 5 kg, most VBIED have an NEQ of less than 20 kg, a few in the hundreds of kg and very few in the tonnes. One method of considering the physical dimensions of the NEQ is to visualise that a 5 kg weight can be held with an outstretched arm, 10 kg can be carried by the side of the body, 20 kg is a heavy two-arm carry and anything above 20 kg will be transported on wheels.

For the assessment the following NEQ (TNT equivalent) are used: For PBIED 10 kg, a comfortable carry for one person and 23 kg being the ‘standard’ size as specified in US documents. For VBIED: 100 kg considered to be a reasonable charge weight and 225 kg, the ‘standard’ size as specified in US documents.

In some embodiments, the receiving device 104 (or multiple receiving devices) calculates the one or more effects of a blast of the explosive device by decoding the virtual RF blast wave based on an explosive charge weight (W) including a kg TNT equivalent of the explosive device, a distance (D), a peak incident pressure (Pi), a peak reflected pressure (Pr), and a peak reflected impulse (Rimp). The peak incident pressure (Pi) may be a pressure experienced if the blast wave travelled across the target surface and a force was applied ‘side on’. The peak reflected pressure (Pr) may be pressure that continues to build until it reaches a point of reflection if the surface not fail, the peak reflected pressure (Pr) being a maximum pressure expected to be experienced by the target surface. The peak reflected impulse (Rimp) may be a pressure applied over a period of time assuming that the target surface does not fail before the peak reflected impulse is achieved. If any additional modeling like, but not limited to, Computational fluid dynamics (CFD) modeling may also be used to calculate the blast effects. These figures/numbers are considered appropriate for blast calculations at this stage. The figures/numbers are rounded out to the nearest single decimal place.

In an exemplary scenario, mWatts per metre is 0.056, Range is 1800, and output may be 2.4 Ghz 100 mW. The following formula may be used for blast calculations:

The RF considerations are selected by reference to ITU (International Telecommunication Union report ITU-R P.2436-1 (June 2016) Compilation of measurement data relating to building. The transmitting device of the explosion simulation system may attenuate the blast wave (or blast wave signal) at a rate of 50 Ohm. The receiving device may show an orange light or a red light according to the values shown in an exemplary table below. The exemplary table shows blast calculations in terms of “Break Glass Distance”, “Slight Chance of Eardrum Rupture” (or Ear Rupture Threshold) for various dial settings or weight of explosive used (in Kg of TNT).

| | | Slight | | | | |
|---|---|---|---|---|---|---|
| | “Break | chance of | | | | |
| | Glass” | Eardrum | Attenuation | | | |
| | Distance | Rupture | @ 50 Ohm | | Attenuation | |
| Dial Setting | Orange | Red | Red Light | DB | R1 in | Attenuation R |
| (in Kg of TNT) | Light? | Light? | in mW | Red | Ohms | 2 in Ohms |
| 0.5 kg | 20 m | 5 m | 0.28 | −25.50 | 55.61 | 469.59 |
| 2.0 kg | 30 m | 8 m | 0.448 | −23.50 | 57.16 | 379.39 |
| 5.0 kg | 40 m | 10 m | 0.56 | −22.50 | 58.11 | 331.51 |
| 10 kg | 50 m | 14 m | 0.784 | −21.10 | 59.66 | 281.55 |
| 17 m (say | | | | | | |
| 20 kg | 65 m | | | | | |
| 15 m) | 0.952 | −20.20 | 60.83 | 253.38 | | |
| 25 kg | 70 m | 18 m | 1.008 | −19.70 | 61.55 | 238.92 |
| 23 m (say | | | | | | |
| 50 kg | 85 m | | | | | |
| 20 m) | 1.288 | −19.10 | 62.48 | 222.62 | | |
| 29 m (say | | | | | | |
| 100 kg | 110 m | | | | | |
| 30 m) | 1.624 | −17.90 | 64.59 | 119.13 | | |

According to the above table, if the dial setting i.e. the weight of the explosive is 0.5 kg then the break glass distance may be up to 20 m and an eardrum rupture distance may be up to 5 m. Similarly, when the dial setting is 2.0 kg, the break glass distance may be up to 30 m and an eardrum rupture distance may be up to 8 m. Similarly, when the dial setting is 5.0 kg, the break glass distance may be up to 40 m and an eardrum rupture distance may be up to 10 m.

In some embodiments, the explosion simulation system calculates the effect of a blast by using the model provided in US Army Technical Manual 5-855-1 ‘Fundamentals for protective design for conventional weapons’.

Then at step 1118, critical structure, utilities, functions within unacceptable effects range is determined. The explosion simulation system may also identify related treatments for mitigation at step 1120. The treatments may be determined in terms of distance, access control of goods and people, screening, structural hardening, policies, and procedures.

Thereafter, the explosion simulation system makes recommendation for mitigation at step 1122. According to another aspect of the present disclosure, the method 1100 may also include controlling, by an initiation system, an initiation of at least five slave devices unable to cross-talk to each other. The initiation system is configured to be used as at least one of a tactical front-line kit and a non-tactical ordnance disposal tool.

According to another aspect of the present disclosure, the method 1100 may also include giving, by a radio frequency based ambush system, an ambush commander warning and a direction of an enemy. The radio frequency based ambush system may include a control module, one or more detection modules, one or more communication modules for team members, and one or more firing circuit indicators for flares and mines.

According to another aspect of the present disclosure, the method may also include providing, by the radio frequency based ambush system, a command and control when an ambush is set.

Referring to the FIG. 12, the firing circuit diagram 1200 of an exemplary initiator of an initiation system is illustrated. The initiation system may include a short-range RF based initiation device for high explosive charges. The initiation system may be used as a remote initiation system. The initiation system includes an ARM switch and a short-range RF based initiation device configured to control initiation of at least five slave devices that are unable to cross-talk to each other. In some embodiments, the short-range RF based initiation device is configured to be used as at least one of a tactical front-line kit and a non-tactical ordnance disposal tool.

The initiation system is designed as a tactical front-line kit but can also be used as a non-tactical Ordnance disposal tool. The firing circuits adhere to the safety protocols required by the Directorate of Ordnance Safety. The initiation system includes a master unit that may have five slaves (hereinafter, may also be referred as slave devices) to control, the principles of operation are: Fire All; Fire 1, 3, 5; Fire 2, 4; Fire 1 or 2 or 3 or 4 or 5; and, Ripple fire all five slaves with a programable delay between the slaves say, 2, 5 or 60 seconds. In some embodiments, the master unit may have more or less than five slaves (slave devices). It is a safety requirement that individual kits (or the slave devices) are unable to “cross talk” to each other. Unique AES identifiers may be used for each kit. The master unit may also include Dedicated chipsets to communicate to its nodes or the slaves.

As shown in the firing circuit diagram 1200, all units are in the “Off” position. A detonator may be connected to terminals on the Initiator module of the initiation system and module S4 is turned on.

Turning now to the FIG. 13, the firing circuit diagram 1300 of the exemplary master unit of the initiation system is shown. On the master unit, S1 module is turned on, a firing sequence switch on S2 is operated. This can be done by lifting the missile cover and operating the S7 switch. This action may inform the electronics module that the system is armed, and may close K1 and send an ack back to the master unit. Fire Switch S7 as shown in the firing circuit diagram 1300 of the master unit may send a signal to the electronics in the initiator module to close relay S5, which will provide power to fire the detonator.

The disclosed system for simulating blast effects of a bomb may use radio frequency (RF). In some embodiments, the RF used is a free-to-air 2.4 GHz Wi-Fi protocol. The RF signal used by the system may be attenuated to match a mass of the explosive used for example, 5 Kg, 10 Kg, 20 Kg, 25 Kg, 50 Kg, and 100 Kg.

The present disclosure provides an explosion simulation system configured to simulate or replicate an extent and pressure of one or more blast waves by ‘dialling in’ a pre-determined amount of explosive using a medium of Radio Frequency (RF). The explosive effects are based on the results of calculations derived from authoritative source. The system is portable and battery powered.

The Master unit in the disclosed explosion simulation system is a ‘detonator’ which, when activated, initiates an RF signal that in turn activates (or not) one or more remote units. The one or more remote units cannot be deactivated by a wearer like training students, etc. The remote units are worn by the students or placed in critical locations.

The disclosed explosion simulation system for simulating blast effects of a bomb may be used as an exercise and training tool for operatives deployed in civil and military Explosive Ordnance Disposal (EOD) and improvised explosive device (IED) environments. Further, the system may be used by risk planners and auditors to assess an extent of a blast (i.e. bomb blast) when planning one or more escape routes and evacuation routes in vulnerable buildings and locations.

The disclosed explosion simulation system for simulating blast effects of an explosive weapon like a bomb may add a new dimension of realism to training and triage management. The disclosed explosion simulation system for simulating blast effects of a bomb gives an indication of the level of damage that exercise participants would receive should an explosive device i.e. the bomb function.

The disclosed explosion simulation system for simulating blast effects of a bomb gives an indication of the level of damage in terms of an ear rupture threshold that exercise participants would receive should an explosive device function.

The present disclosure provides a simulation system configured to replicate the blast effects of an explosive weapon like a bomb with a charge size of from 100 grams to 200 kg.

The present disclosure provides an explosion simulation system for simulating effects of a bomb. The system is designed to have a robust environment resistant construction and can be operated in any combination of cold, hot, dusty, or wet conditions.

The present disclosure provides systems and methods for simulating and replicating blast effects of an explosive like a bomb during military training exercises. A system includes a transmitting device configured to connect to an improvised explosive device. The transmitting device (may also be referred as TX or a detonator) after connecting to the improvised explosive device (IED) and triggering, may transmit a radio frequency (RF) virtual blast. The system also includes a receiving device (RX) configured to receive the RF virtual blast and display the blast severity in one of three categories comprising a glass breakage, an ear rupture, and a blast lung injury dependent on a distance from a source and its magnitude.

In some embodiments, the explosive system simulator comprises a pelican case housing at least one transmitting device, at least five receiving devices, at least five low gain antennas, a unity gain antenna, a 240V to 9 VDC plug pack, and a simulator IED trigger device for training situations in which a powered LED is not available.

In some embodiments, a receiver unit of the system have a robust design and compact construction. The receiving device includes a power on/off key switch so that only a designated user like an ‘Umpire’ can deactivate or reset the receiving device. The receiver unit also includes a power/status indicator, e.g. a green LED. The receiving device produces an audible signal to identify which number i.e. 1 to 5, the receiving device is. The receiving device includes a glass breakage LED indicator, an ear rupture LED indicator, and a blast lung LED indicator. Further, the receiving device includes replaceable alkaline battery like a 9V alkaline battery to allow days of continuous operation. Further, the receiving device includes a clip fixing system. The receiving device is configured to decodes the received RF virtual blast and displays the blast severity.

The disclosed explosion simulation system for simulating and replicating the blast effects of a bomb is environmentally safe.

The disclosed explosion simulation system for simulating and replicating the blast effects of a bomb have a robust design, and is capable of operating in any combination of cold, hot, dusty, and wet conditions. (It is still assumed however that the user exercises some common sense as the unit is environment resistant not environment proof).

The disclosed explosion simulation system for simulating and replicating the blast effects of a bomb includes a power on/off key switch. The disclosed system includes a first push (Blue) button switch for giving at least one of Enter, Set, Status functions. The system also includes a second push button (Red) switch for giving Previous and Decrement functions. The system also includes a third (Green) push button switch for giving a Next and an Increment functions. The disclosed system also includes at least two lines with 20-character display showing system set-up and status.

The disclosed explosion simulation system also includes a pair of 4 mm binding posts to connect to an IED trigger output. The explosion simulation system also includes a pair of 4 mm binding posts connected in parallel to the abovementioned binding posts, acting as a ‘loop through’ to connect to a training a detonator/slab device.

In some embodiments, the disclosed explosion simulation system is configured to emit a frequency that may pass through glass and thin (e.g. a plaster sheet) walls but may have some degree of reflection/attenuation by solid (double brick, concrete and steel reinforced) walls.

In some embodiments, the disclosed explosion simulation system provides a menu driven user interface to allow the user to vary the TNT (Trinitrotoluene) equivalent charge weights. The TNT is a compound used in dynamite. The disclosed explosion simulation system may also provide menu driven status pages. In some embodiments, the disclosed transmitting device of the explosion simulation system is configured for burst transmission of a signal with error detection and automatic retry.

The disclosed explosion simulation system for simulating and replicating the blast effects of a bomb is power-able from a DC (direct current) plug pack, or by six (or more) replaceable ‘C-cell’ alkaline batteries.

An embodiment of the present disclosure provides a system including an explosion simulation system, an initiation system, and a RF based ambush system. The explosion simulation system includes a transmitting explosive device connected to an explosive device including an improvised explosive device (IED). The transmitting device transmits a virtual radio frequency (RF) blast wave upon activation. the RF blast wave comprises a free-to-air 2.4 Gigahertz (GHz) Wi-Fi protocol. The transmitting device (or an attenuator of the transmitting device) attenuates the virtual radio frequency (RF) blast wave to match a mass of notional explosives used in the explosive device. In some embodiments, the virtual RF blast wave comprises a blast wave that would have been generated by an actual explosion of the explosive device. In some embodiments, the transmitting device is configured to transmit a frequency that passes through a glass and thin walls but has some degree of reflection/attenuation by solid walls.

In some embodiments, the transmitting device further includes a power on/off key switch for the transmitting device is configured to transmit a frequency that passes through a glass and thin walls but has some degree of reflection/attenuation by solid walls. The transmitting device may further include one or more push button switches for providing an enter, a set, a status, a previous, a decrement, a next, and increment functions. The transmitting device may further include at least two lines with twenty-character display showing a system set-up and a status. The transmitting device may further include a pair of first binding posts configured to connect to the explosive device including an IED trigger output. The transmitting device may also include a pair of second binding posts connects in parallel to the pair of first binding posts acting as a ‘loop through’ to connect to the transmitting device. The transmitting device may further include a menu driven user interface for allowing a user to vary a TNT equivalent charge weights, and one or more menu driven status pages.

The explosion simulation system includes one or more remote receiving devices including an audible alarm to indicate when the virtual radio frequency (RF) blast wave is received from the transmitting device. The one or more receiving devices are configured to: get activated upon receiving the virtual RF blast wave from the transmitting device; calculate one or more effects of a blast of the explosive device by decoding the virtual RF blast wave based on an explosive charge weight (W) comprising a kg TNT equivalent of the explosive device, a distance (D), a peak incident pressure (Pi), a peak reflected pressure (Pr), and a peak reflected impulse (Rimp); and display the one or more effects of the blast in at least one category comprising an ear rupture threshold, a glass breakage threshold, and a blast lung threshold. In some embodiments, the explosion simulation system further comprising at least five low gain antennas, one unity gain antenna, a 240V to 9V direct current plug pack and a simulated TED trigger device for training situation in which the powered explosive device is unavailable. In some embodiments, the one or more receiving devices calculates the one or more effects of the blast based on an assumption that the blast wave strikes a target surface at 90 degrees. The peak incident pressure (Pi) being a pressure experienced if the blast wave travelled across the target surface and a force was applied ‘side on’. The peak reflected pressure (Pr) being a pressure that continues to build until it reaches a point of reflection if the surface not fail, the peak reflected pressure (Pr) being a maximum pressure expected to be experienced by the target surface. Further, the peak reflected impulse (Rimp) is the pressure applied over a period of time assuming that the target surface does not fail before the Rimp is achieved.

In some embodiments, the the one or more receiving devices may include one or more light emitting diode (LED) indicators for displaying the one or more effects of the blast in at least one category. Further, the transmitting device and the one or more receiving devices are environment resistant and are configured to operate in different environmental conditions. Furthermore, the transmitting device and the one or more receiving devices are portable and battery operated.

The initiation system of the system may be for high explosive charges. The initiation system comprising an ARM switch and a short-range RF based initiation device for controlling an initiation of at least five slave devices that are unable to cross-talk to each other. The short-range RF based initiation device may be used as a tactical front-line kit.

In some embodiments, the radio frequency based ambush system of the system includes a control module, one or more detection modules, one or more communication modules for team members, an ARM switch, and one or more firing circuit indicators for flares and mines, wherein the radio frequency based ambush system is configured to give an ambush commander warning and a direction of an enemy; and provide a command and control when the ambush is set.

Another embodiment of the present disclosure also provides a method for simulating blast effects of an explosive device. The method includes transmitting, by a transmitting device connected to the explosive device, a virtual radio frequency (RF) blast wave upon activation, wherein the RF blast wave comprises a free-to-air 2.4 Gigahertz (GHz) Wi-Fi protocol, wherein the virtual radio frequency (RF) blast wave is attenuated to match a mass of notional explosives used in the explosive device. The method also includes activating the one or more remote receiving devices upon receiving the virtual RF blast wave, by the one or more remote receiving devices, from the transmitting device. Further, the method includes calculating, by the one or more remote receiving devices, one or more effects of a blast of the explosive device by decoding the virtual RF blast wave based on an explosive charge weight (W) comprising a kg TNT equivalent of the explosive device, a distance (D), a peak incident pressure (Pi), a peak reflected pressure (Pr), and a peak reflected impulse (Rimp). Furthermore, the method includes displaying, by the one or more remote receiving devices, the one or more effects of the blast in at least one category comprising an ear rupture threshold. In some embodiments, the peak incident pressure (Pi) being a pressure experienced if the blast wave travelled across the target surface and a force was applied ‘side on’, wherein the peak reflected pressure (Pr) being a pressure that continues to build until it reaches a point of reflection if the surface not fail, the peak reflected pressure (Pr) being a maximum pressure expected to be experienced by the target surface, further wherein the peak reflected impulse (Rimp) being the pressure applied over a period of time assuming that the target surface does not fail before the Rimp is achieved. In some embodiments, the explosive device comprises an improvised explosive device (IED). Further, the virtual RF blast wave may include a blast wave that would have been generated by an actual explosion of the explosive device. In some embodiments, the one or more effects of the blast are calculated based on an assumption that the blast wave strikes a target surface at 90 degrees. The method also includes displaying the one or more effects of the blast in at least one category comprising a glass breakage threshold, the ear rupture threshold, and a blast lung threshold. In some embodiments, the method further includes displaying the one or more effects of the blast in at least one category via one or more light emitting diode (LED) indicators of the one or more receiving devices. The method also includes transmitting, by the transmitting device, a frequency that passes through a glass and thin walls but has some degree of reflection/attenuation by solid walls. The method also includes controlling, by an initiation device, an initiation of at least five slave devices unable to cross-talk to each other, wherein the initiation device is configured to be used as at least one of a tactical front-line kit and a non-tactical ordnance disposal tool. The method also includes giving, by a RF based ambush system, an ambush commander warning and a direction of an enemy. The RF based ambush system includes a control module, one or more detection modules, one or more communication modules for team members, and one or more firing circuit indicators for flares and mines. The method also includes providing a command and control when an ambush is set.

The present disclosure provides a radio frequency (RF) based tactical command and control (C2) system which supports a range of small combat team operations (ambush, covert explosive initiation, remote surveillance, and perhaps, a “platoon in defence kit”) rather than a range of stand-alone products. The RF based tactical Command and Control System (TaCCS) is a light weight, portable, highly effective command and control system capable of threat evaluation, weapon assignment and air defence support functions.

Another embodiment of the present disclosure provides an initiation system including an arm switch and a short-range frequency based initiation device. The short-range frequency based initiation device is configured to control an initiation of at least five slave devices that are unable to cross-talk to each other. The short-range radio frequency based initiation device is configured to be used as at least one of a tactical front-line kit and a non-tactical ordnance disposal tool. The disclosed initiation system is portable and battery operated. The disclosed system including an explosion simulation system, an initiation system, and an ambush system (or RF based ambush system) is portable and battery operated.

Another embodiment of the present disclosure provides an ambush system. The ambush system is a radio frequency based (RF) ambush system. The RF based ambush system may include a control module configured to provide a command and control when an ambush is set; one or more detection modules configured to detect one or more ambushes; one or more communication modules for team members, the one or more communication modules are configured to give an ambush commander warning and a direction of an enemy; one or more firing circuit indicators for flares and mines; an ARM switch; and a Wi-Fi unit/module configured to be programmed and enable at least two ambush systems to operate in close proximity without mutual interference. The one or more modules of the ambush system includes software, firmware, hardware, and combination of these. The ambush system (or RF based ambush system) is portable and battery operated.

In some embodiments, the explosion simulation system may operate in the GSM 4 Meshed Private Network to simulate the free-field incident blast over-pressure from an explosive device. The explosion simulation system may include a master transmitter unit (also referred as a transmitting device throughout the description). When triggered, the master transmitter (TX) unit transmits an addressed, coded RF message that is received by individual receiver (RX) units. Each RX unit checks the transmitted address, and, if correctly addressed, decodes the transmitted message and displays an expected injury severity derived from the RX unit's received signal strength intensity using modified remote initiation system.

The explosion simulation system has been designed for simple system operation, set-up and monitoring. In an embodiment, the TX unit features an LCD displaying a simple menu, allowing the user to select from a range of TNT equivalent Explosive Ordnance (EO) weights; system parameters; overall system status and individual RX unit status. Further, the RX unit may feature a type of damage Light Emitting Diodes (LEDs) displaying calculated injury severity; On-Off status and Charging. The explosion simulation system also includes a RF attenuator circuit to best simulate the chosen explosive weight to an attenuated RF signal; this must be consistent throughout all iterations of the production units. A test unit will be designed to measure and accept or reject the attenuator module or board. This can be achieved by using an adapted internal RF generator with external measurement, and explosive power selection via a switch or production module.

In some embodiments, the master unit is capable of an automatic power output step up e.g. when 5 Type 1 receivers are deployed, they will ack when switched on. Deployed the Master unit will start at the lowest power output and automatically step-up through the power setting, say with a 5 second delay. The Receivers will report back if triggered. The Receiver No and the power need to set the unit off will be recorded. So, unit 2 triggered at power level 3 (5 Kg TNT).

In some embodiments, the transmitting device of the explosion simulation system may be microprocessor controlled. The transmitting device may be changed from 151 Mhz to 2.4 Mhz Zigbee HP Unit High Power Zigbee Unit or GSM 4 Meshed Private Network. The transmitted device may include integrated Lithium batteries with USB charger. The transmitting device may use high reliability surface mount technology. The transmitting device is configured for unique individual unit addressing and is electrically isolated and protected trigger input. The transmitting device function is menu driven. For example, the Zigbee High Power Unit indication a range of 1000 metres to 1600 metres in ideal conditions, the output needs to be measured distance and signal strength at the antenna and real distance then the attenuation circuit can be calculated.

In some embodiments, the explosion simulation system may require two antenna outputs i.e. an omni-directional and a horn type direction beam. In some embodiments, the explosion simulation system includes a processor capable of standard software configuration and the addition of optional requirements such as, but not limited to, plume and fragmentation. The transmitting device or the master unit may have a physical on/off switch, in addition the master unit can control the re-setting of Type 1 Receivers. Button Receivers will be reset on the unit.

In some embodiments, the one or more remote receiving devices comprise Type 1 Receiver (Standard) that may include an antenna. The antenna may be repositioned to the top of the unit using a 0 Db stub antenna. Same batteries as for initiation system slaves, with USB charging. The receiving devices may include an On/Off switch, LEDs for On, and an LED to indicate lung damage.

In some embodiments, the one or more remote receiving devices comprise a button receiver that is receive only. It can be sent a code which will identify the threat i.e. fragmentation or CBRNE. The unit can be powered by an internal battery of the Hearing Aid type or a CR type battery. In some embodiments, an internal antenna may be used, the enclosure may also include a method of attachment to a uniform lapel. The button receiver may have two LED indicators (either separate LEDs or a dual colour LED). It is possible that there may be a requirement for a third LED to indicate blast.

In some embodiments the master unit includes a menu driven user interface or a Menu Control and may require menu inputs. These can either be as used by the initiation system Master (or control module) or by a thumb joystick. The master unit also includes a display and an attenuator circuit. The attenuator circuit may require careful consideration as it is dependent on the Zigbee RF output, these figures will be available after trials of the TX/RX modules. The Type 1 Receivers 1 will be addressable and will be able to communicate to the Master unit by a unique ID; this will allow status updates to be sent: On, Ready and Current Status. The Button will be Receive only.

The disclosed explosion simulation system is in accordance with environmental/electronic Standards. Basics standards will apply, IP 65, EMI, EMC, CE. Shock and vibration will comply to ruggedized commercial. The batteries of the system may be Lithium Polymer, and utilise USB charging. In some embodiments, the button receivers may use a disposable battery such as Hearing Aid, Watch, or CR type.

In some embodiments, the transmitting device may include a port for an external trigger, similar to the V1 unit, for IEDD Training. A standard trigger may also be incorporated in the transmitting device (or the Master Unit).

In some embodiments, the disclosed explosion simulation system is configured to Calculate blast effective yield based on Net Explosive Quantity and the TNT equivalence assigned to the type of explosives being consideration; and show a range of Blast Wave Characteristics, including the blast scaled factor based on Explosive yield and user entered range. The ranges can be extended by ‘meshing’ the units—the Zigbee architecture lends itself to a meshed network. Using TNT as the basic unit, the effect of other explosives (TATP, ANFO, Torpex, C4, Semtex, and RDX for example) can be scaled (plus or minus) comparatively to the effect of TNT. ‘TNT equivalency’ is a well-established method of comparing explosives.

The following exemplary blast tables present the pressures expected to be experienced by the target at set distances. These are ‘Peak Incident Pressures’ i.e. the initial impact of the blast as it passes over/around the person. It is not expected that there will be much resistance to the blast so ‘Reflected Pressure’ is not shown.

Anyone closer than the shown distances can be expected to have suffered injury. For design purposes, the Rx should not respond beyond these distances for the selected charge weight. The pressures of 207 kPa and 34 kPa are taken from US Federal Emergency Management Agency FEMA 426 “Reference Manual to Mitigate Potential Terrorist Attacks Against Buildings” Table 3.1 quoting US Department of Defence 3-340-02, “Structures to Resist the Effects of Accidental Explosions” (2008b). The figure of 5 psi for threshold of ear damage is converted to 34 kPa; the figure of 30 psi for threshold of lung damage converted to 207 kPa. These figures are considered accurate enough for the explosion simulation system to emulate blast effects.

The pressure/distance figures were calculated using US WES CONWEP TM5-855, a well validated model. Figures are rounded to nearest metre.

TABLE 1
Pressure/Distance:

| | Ear damage | Lung damage |
|---|---|---|
| Charge | threshold | threshold |
| weight in kg | (~34 kPa) | (~207 kPa) |
| (TNT) | in ~m | in ~m |
| 2 | 7 | 3 |
| 5 | 10 | 4 |
| 10 | 13 | 5 |
| 25 | 17 | 7 |
| 50 | 21 | 8 |
| 100 | 27 | 11 |
| 200 | 34 | 13 |
| 250 | 36 | 15 |

As can be seen in the Table 1, the distances between the smaller charge weight is minimal. As the ear damage threshold is the greater distance it is recommended this distance be used when aligning the Rx to the selected charge weights. Reducing the number of charge weights available to provide some distance between readings while still providing a suitable range resulted in the following recommended selectable charge weights:

TABLE 2
Recommended Pressure/Distances

| | Ear damage |
|---|---|
| Charge | threshold |
| weight in kg | (~34 kPa) |
| (TNT) | in ~m |
| 2 | 7 |
| 10 | 13 |
| 25 | 17 |
| 100 | 27 |
| 250 | 36 |

The calculations assume: Full detonation of the well-constructed explosive material; Hemispherical surface burst; No increase of pressure due to reflective surfaces.

The figures do not include damage and injury from fragmentation.

Fragmentation Table

| Type | Range | Notes |
|---|---|---|
| 155 mm | 150 metres | Check |
| 105 mm | 150 metres | |
| 120 mm Mortar | 76 metres | |
| 81 mm Mortar | 55 metres | |
| 60 mm Mortar | 40 metres | MAPAM Round |
| Hand Grenade | 15 metres | |

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

1. A system for simulating blast effects of an explosive device, comprising:
an explosion simulation system comprising:
a transmitting device connected to the explosive device, wherein the transmitting device is configured to:
transmit a virtual radio frequency blast wave upon activation, wherein the virtual radio frequency blast wave comprises a free-to-air 2.4 Gigahertz (GHz) Wi-Fi protocol; and
adapt the virtual radio frequency blast wave to include characteristics to match a mass of explosives used in the explosive device; and
one or more remote receiving devices comprising an audible alarm configured to indicate when the virtual radio frequency blast wave is received from the transmitting device, the one or more receiving devices are configured to:
get activated upon receiving the virtual radio frequency blast wave from the transmitting device;
calculate one or more effects of a blast of the explosive device by decoding the virtual radio frequency blast wave based on an explosive charge weight (W) comprising a kg TNT equivalent of the explosive device, a distance (D), a peak incident pressure (Pi), a peak reflected pressure (Pr), and a peak reflected impulse (Rimp); and
display the one or more effects of the blast in at least one category comprising an ear rupture threshold.

2. The system of claim 1, wherein the transmitting device is configured to attenuate the virtual radio frequency blast wave to match a mass of explosives used in the explosive device.

3. The system of claim 2, wherein the explosive device comprises an improvised explosive device (IED) and further comprises at least five low gain antennas, one unity gain antenna, a 240V to 9V direct current plug pack and a simulated improvised explosive device trigger device for training situation in which the powered explosive device is unavailable.

4. The system of claim 1, wherein the virtual radio frequency blast wave comprises a blast wave that would have been generated by an actual explosion of the explosive device.

5. The system of claim 1, wherein the one or more receiving devices calculates the one or more effects of the blast based on an assumption that the blast wave strikes a target surface at 90 degrees, wherein the peak incident pressure (Pi) being a pressure experienced if the blast wave travelled across the target surface and a force was applied ‘side on’, wherein the peak reflected pressure (Pr) being a pressure that continues to build until it reaches a point of reflection if the surface not fail, the peak reflected pressure (Pr) being a maximum pressure expected to be experienced by the target surface, further wherein the peak reflected impulse (Rimp) being the pressure applied over a period of time assuming that the target surface does not fail before the peak reflected impulse is achieved.

6. The system of claim 1, wherein the one or more receiving devices are configured to display the one or more effects of the blast in at least one category comprising a glass breakage threshold, the ear rupture threshold, and a blast lung threshold, further wherein the one or more receiving devices comprises one or more light emitting diode indicators for displaying the one or more effects of the blast for the at least one category.

7. The system of claim 1, wherein the transmitting device further includes:
a power on/off key switch for switching on and switching off the transmitting device;
one or more push button switches for providing one or more functions comprising an enter, a set, a status, a previous, a decrement, a next, and an increment;
at least two lines with twenty-character display showing a system set-up and a status;
a pair of first binding posts configured to connect to the explosive device comprising an improvised explosive device trigger output;
a pair of second binding posts connects in parallel to the pair of first binding posts acting as a ‘loop through’ to connect to the transmitting device; and
a menu driven user interface for allowing a user to vary a TNT equivalent charge weights, and a menu driven status page.

8. The system of claim 7, wherein the transmitting device is further configured to transmit a frequency that passes through a glass and thin walls but has a degree of reflection/attenuation by solid walls.

9. The system of claim 8, wherein the transmitting device and the one or more receiving devices are environment resistant and are configured to operate in different environmental conditions, further wherein the transmitting device and the one or more receiving devices are portable and battery operated.

10. An explosion simulation system comprising:
a transmitting device connected to an explosive device comprising an improvised explosive device (IED), wherein the transmitting device is configured to:
transmit a virtual radio frequency blast wave upon activation, wherein the virtual radio frequency blast wave comprises a free-to-air 2.4 Gigahertz (GHz) Wi-Fi protocol; and
attenuate the virtual radio frequency blast wave to match a mass of notional explosives used in the explosive device;
one or more remote receiving devices comprising an audible alarm configured to indicate when the virtual radio frequency blast wave is received from the transmitting device, the one or more receiving devices are configured to:
get activated upon receiving the virtual radio frequency blast wave from the transmitting device;
calculate one or more effects of a blast of the explosive device by decoding the virtual radio frequency blast wave based on an explosive charge weight (W) comprising a kg TNT equivalent of the explosive device, a distance (D), a peak incident pressure (Pi), a peak reflected pressure (Pr), and a peak reflected impulse (Rimp); and
display the one or more effects of the blast in at least one category comprising an ear rupture threshold, a glass breakage threshold, and a blast lung threshold; and
a plurality of low gain antennas, one unity gain antenna, a 240V to 9V direct current plug pack and a simulated IED trigger device for training situation in which the powered explosive device is unavailable.

11. The explosion simulation system of claim 10, wherein the virtual radio frequency blast wave comprises a blast wave that would have been generated by an actual explosion of the explosive device.

12. The explosion simulation system of claim 10, wherein the one or more receiving devices calculates the one or more effects of the blast based on an assumption that the blast wave strikes a target surface at 90 degrees.

13. The explosion simulation system of claim 10, wherein:
the one or more receiving devices comprises one or more light emitting diode indicators for displaying the one or more effects of the blast in at least one category;
the peak incident pressure (Pi) being a pressure experienced if the blast wave travelled across the target surface and a force was applied ‘side on’;
the peak reflected pressure (Pr) being a pressure that continues to build until it reaches a point of reflection if the surface not fail, the peak reflected pressure (Pr) being a maximum pressure expected to be experienced by the target surface;
the peak reflected impulse (Rimp) being the pressure applied over a period of time assuming that the target surface does not fail before the Rimp is achieved;
the transmitting device and the one or more receiving devices are environment resistant and are configured to operate in different environmental conditions; and
the transmitting device and the one or more receiving devices are portable and battery operated.

14. The explosion simulation system of claim 10, wherein the transmitting device is further configured to:
transmit a frequency that passes through a glass and thin walls but has a degree of reflection/attenuation by solid walls; and
burst transmission of the blast wave with error detection and an automatic retry.

15. The explosion simulation system of claim 14, wherein the transmitting device further includes:
a power on/off key switch for switching on and switching off the transmitting device;
one or more push button switches for providing one or more functions comprising at least one of an enter, a set, a status, a previous, a decrement, a next, and an increment function;
at least two lines with multi-character display showing a system set-up and a status;
a pair of first binding posts configured to connect to the explosive device comprising an IED trigger output;
a pair of second binding posts connects in parallel to the pair of first binding posts acting as a ‘loop through’ to connect to the transmitting device; and
a menu driven user interface for allowing a user to vary a TNT equivalent charge weights, and one or more menu driven status page.

16. A method for simulating blast effects of an explosive device, the method comprising:
transmitting, by a transmitting device connected to the explosive device, a virtual radio frequency blast wave upon activation, wherein the virtual radio frequency blast wave comprises a free-to-air 2.4 Gigahertz (GHz) Wi-Fi protocol, wherein the virtual radio frequency blast wave is attenuated to match a mass of explosives used in the explosive device;
providing one or more remote receiving devices comprising an audible alarm configured to indicate when the virtual radio frequency blast wave is received from the transmitting device, wherein the one or more remote receiving devices are configured to;
get activated upon receiving the virtual radio frequency blast wave from the transmitting device;
calculate one or more effects of a blast of the explosive device by decoding the virtual radio frequency blast wave based on an explosive charge weight (W) comprising a kg TNT equivalent of the explosive device, a distance (D), a peak incident pressure (Pi), a peak reflected pressure (Pr), and a peak reflected impulse (Rimp); and
display the one or more effects of the blast in at least one category comprising an ear rupture threshold.

17. The method of claim 16, wherein the explosive device comprises an improvised explosive device (IED), wherein the virtual radio frequency blast wave comprises a blast wave that would have been generated by an actual explosion of the explosive device.

18. The method of claim 17, wherein:
the one or more effects of the blast are calculated based on an assumption that the blast wave strikes a target surface at 90 degrees;
the peak incident pressure (Pi) being a pressure experienced if the blast wave travelled across the target surface and a force was applied ‘side on’;
the peak reflected pressure (Pr) being a pressure that continues to build until it reaches a point of reflection if the surface not fail, the peak reflected pressure (Pr) being a maximum pressure expected to be experienced by the target surface; and
the peak reflected impulse (Rimp) being the pressure applied over a period of time assuming that the target surface does not fail before the Rimp is achieved.

19. The method of claim 18 further comprising:
displaying the one or more effects of the blast in at least one category comprising a glass breakage threshold, the ear rupture threshold, and a blast lung threshold, wherein the one or more effects of the blast in at least one category are displayed via one or more light emitting diode (LED) indicators of the one or more receiving devices; and
transmitting, by the transmitting device, a frequency that passes through a glass and thin walls but has some degree of reflection/attenuation by solid walls.

20. The method of claim 19 further comprising providing at least five low gain antennas, one unity gain antenna, a 240V to 9V direct current plug pack and a simulated improvised explosive device trigger device for training situation in which the powered explosive device is unavailable.
